(19) United States
(12) Patent Application Publication
(10) Pub. No.: US 2026/0371257 A1
(43) Pub. Date: Nov. 19, 2026

(54) METHOD AND APPARATUS FOR SUPPORTING WIRELESS COMMUNICATION WITH ENERGY HARVEST

(71) Applicant: APPLE INC., Cupertino, CA (US)

(72) Inventors: Haitong Sun, Cupertino, CA (US); Dawei Zhang, Saratoga, CA (US); Alexander Sirotkin, Hod Hasharon (IL); Wei Zeng, San Diego, CA (US); Zhibin Wu, Los Altos, CA (US); Haijing Hu, Los Gatos, CA (US); Mona Agnel, Guildford (GB); Sudeep Manithara Vamanan, Uttenreuth (DE); Naveen Kumar R Palle Venkata, San Diego, CA (US)

(21) Appl. No.: 19/102,144

(22) PCT Filed: Aug. 9, 2023
(86) PCT No.: PCT/US2023/071889

§ 371 Date: Feb. 7, 2025

Related U.S. Application Data
(60) Provisional application No. 63/371,173, filed on Aug. 11, 2022.

(51) Int. Cl. H04W 52/14; H04B 5/79; H04W 52/34; H04W 52/36

(52) U.S. Cl. CPC H04W 52/146; H04B 5/79; H04W 52/34; H04W 52/365; H04W 52/367

(57) ABSTRACT

A user equipment includes an antenna configured to receive a plurality of radio frequency (RF) signals from a base station or a another UE device and an energy harvest module coupled to the antenna and configured to receive the plurality of RF signals and to harvest energy from individual ones of the plurality of RF signals having near-field effect compatible carrier frequency. The UE further includes a wireless communications module coupled to the antenna and configured to receive the plurality of RF signals and to decode individual ones of the plurality of RF signals having far-field effect compatible frequency using the energy harvested by the energy harvest module.

### CROSS-REFERENCE TO RELATED APPLICATIONS

This application claims priority to U.S. Provisional Application Ser. No. 63/371,173, filed Aug. 11, 2022, entitled “Method and Apparatus for Supporting Wireless Communication with Energy Harvest,” the entire disclosure of which is hereby incorporated by reference in its entirety into the present disclosure.

### TECHNICAL FIELD

This application relates generally to wireless communication systems, including wireless communication devices that use energy harvesting.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a high level architecture of a wireless communication device using energy harvesting in accordance with certain embodiments.

FIG. 2 is a table illustrating values associated with different power classes in certain NR systems.

FIG. 3 illustrates a single entry power headroom (PH) media access control (MAC) control element (CE) according to certain embodiments.

FIG. 4A is a table illustrating PHR report mapping in accordance with one embodiment.

FIG. 4B is a table illustrating mapping of P_(CMAX,f,c) according to certain embodiments.

FIG. 5 is a signal diagram illustrating between a UE and a network (NW) for UE PHR report enhancement according to one embodiment.

FIG. 6 illustrates an example architecture of a wireless communication system, according to embodiments disclosed herein.

FIG. 7 illustrates a system for performing signaling between a wireless device and a network device, according to embodiments disclosed herein.

FIG. 8 illustrates a flowchart for a method to harvest RF energy for wireless communications, according to embodiments disclosed herein.

FIG. 9 illustrates a flowchart for a method to operate a base station to communicate with a UE that harvests RF energy for wireless communications, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

For certain wireless communication systems, there is momentum to look at support of passive internet of things (IoT) devices. There may be considerable interest, for example, from various groups including operators, infra-vendors, and UE vendors to support passive IoT devices in NR systems. A motivation to support passive IoT devices may be to provide more competitive solution, for example, as compared to techniques like radio frequency identification (RFID). Further, new IoT technology may provide complexity and power consumption orders of magnitude lower than existing low power wide area (LPWA) technologies (e.g., narrow band IoT (NB-IoT) and enhanced machine type communication (eMTC)). For example, UE power consumption may be on the order of 1 micro Watt (μW) to 100 μW. Also, new IoT technology may include battery-less devices or devices with energy storage that does not need to be replaced or recharged manually.

One passive IoT solution is to rely on energy harvesting, which includes harvesting energy from an external radio frequency (RF) field or other sources like light, heat, vibration, etc.

Wireless communication with energy harvesting has advantages such as being more environmental friendly by removing or relaxing reliance on batteries. Further, the life cycle of a device may be improved because the device can operate for a long time without needing external intervention or maintenance such as replacing or recharging the battery. However, the frequency that can provide energy harvesting can be different from the frequency for communication, and/or the communication range may be limited by energy harvesting.

Thus, certain embodiments disclosed herein provide solutions to allow wireless communication relying on energy harvesting, including solutions for UE capability reporting, UE power headroom report (PHR) enhancement, and UE energy status report (ESR).

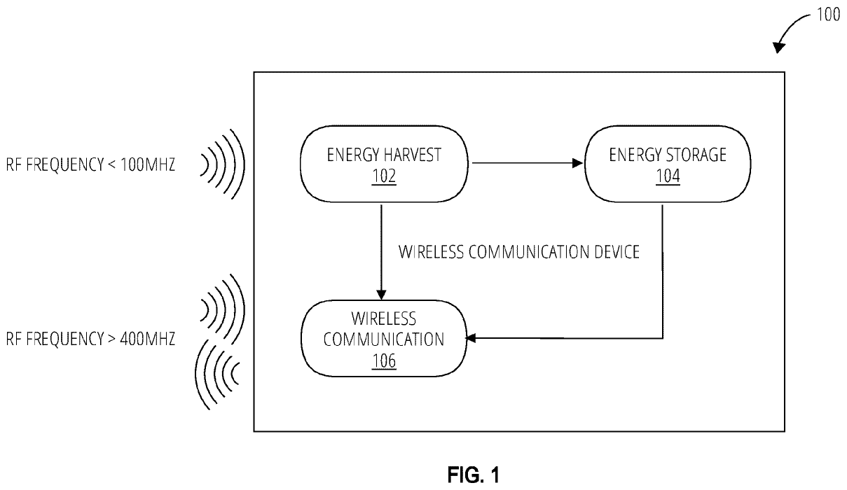

FIG. 1 is a block diagram illustrating a high level architecture of a wireless communication device 100 using energy harvesting in accordance with certain embodiments. The example wireless communication device 100 includes an energy harvest module 102, an optional energy storage module 104, and a wireless communication module 106. In some examples, the energy harvest module 102 may be implemented by software components (e.g., executed by a DSP or a general processor), hardware components (e.g., logic gates and circuitry) within a processor or transceiver, or any combination thereof. In some examples, the wireless communication module 106 may be implemented by software components (e.g., executed by a DSP or a general processor), hardware components (e.g., logic gates and circuitry) within a processor or transceiver, or any combination thereof. The energy harvest module 102 is configured for RF field energy harvesting. The wavelength for energy harvesting by the energy harvest module 102 may be large enough to have a near field effect (i.e., so as to harvest energy from a nearby RF transmitter). Thus, the frequency used by the energy harvest module 102 is low enough to avoid interference with the wireless communication module 106 (e.g., in the illustrated example, the RF frequency used by the energy harvest module 102 is less than 100 MHZ).

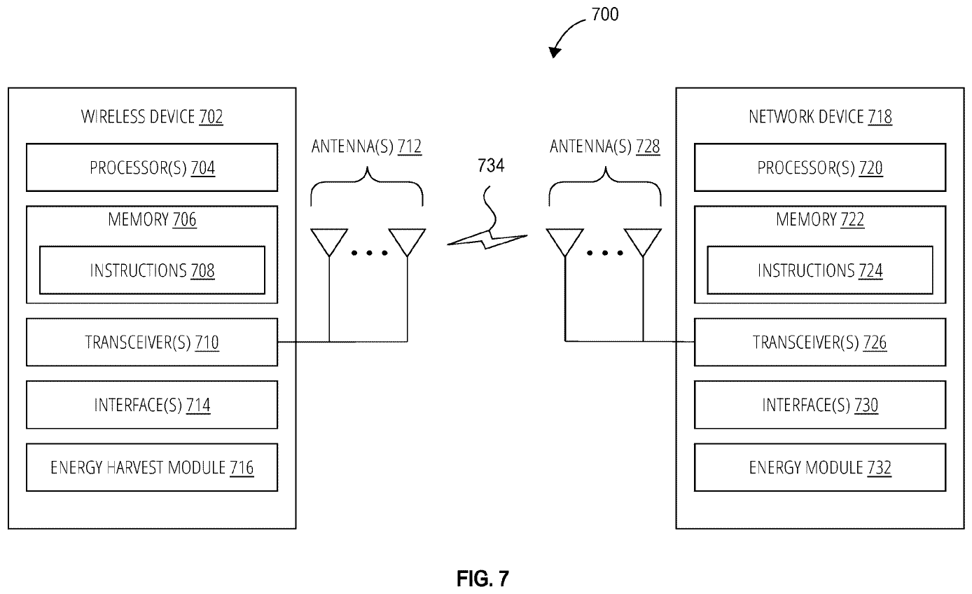

The wireless communication module 106 receives and uses harvested energy from the energy harvest module 102 (optionally through the energy storage module 104) for wireless communication. The wireless communication module 106 may comprise, for example, transceiver(s) 710 discussed with respect to FIG. 7. The wireless communication module 106 uses a wavelength small enough to communicate with a far field. Thus, the frequency used by the wireless communication module 106 is high enough to avoid interference from the RF used by the energy harvest module 102 (e.g., in the illustrated example, the RF frequency used by the wireless communication module 106 is greater than 400 MHZ).

In some examples, the wireless communication module 106 may operate exclusively using power from the energy harvest module 102. In other examples, the energy storage module 104 may optionally be charged by the harvested energy from the energy harvest module 102 to provide stored energy to power the wireless communication module 106. The energy storage module 104 may comprise, for example, a battery.

### UE Capability Reporting

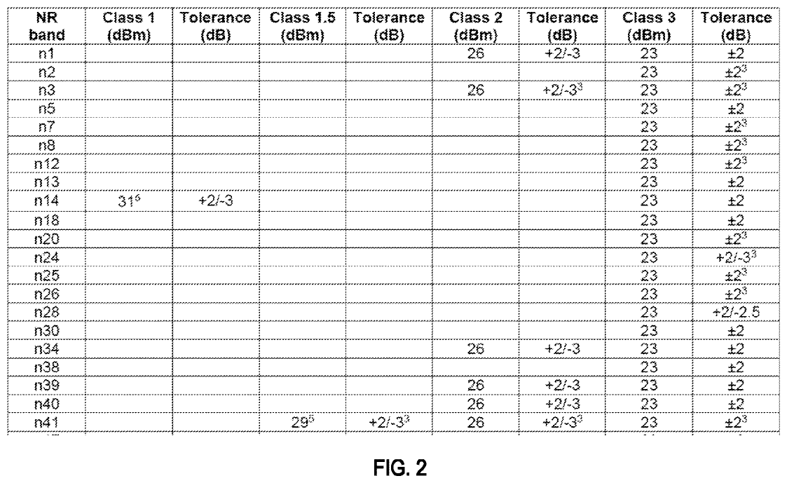

In certain embodiments, to handle the reduced transmit power of wireless communication with energy harvesting, one or more new power classes can be defined for the wireless communication device. The new power class may correspond to one or multiple of the following: reduced maximum transmit power; relaxed tolerance; and/or smaller uplink (UL) duty cycle. Note that current NR systems may only have power classes 1/2/1.5/3. For example, FIG. 2 is a table illustrating values associated with different power classes in certain NR systems. In some examples, the new power class may have a maximum transmit power of −30 dBm to −10 dBm.

In certain embodiments, to handle the low complexity and low power consumption wireless communication with energy harvesting, a new UE category is introduced. The new category may be characterized as one or multiple of the following: reduced maximum number of downlink (DL) multiple input multiple output (MIMO) layers (receive (Rx) antennas); reduced maximum number of UL MIMO layers (transmit (Tx) antennas); reduced number of hybrid automatic repeat request (HARQ) processes; reduced maximum bandwidth; reduced modulation and coding scheme (MCS) support; reduced maximum UL and/or DL duty cycle; reduced maximum peak UL and/or DL peak data rate; and/or no support for carrier aggregation (CA) (i.e., only single component carrier (CC) operation.

In certain embodiments, when a new power class and/or new UE category is introduced for a wireless communication device with energy harvesting, the network (NW) may be informed with the new power class and/or new UE category by a UE capability report or by association between the UE device ID and the new power class and/or new UE category.

### UE PHR Report Enhancement

Compared to a conventional battery, energy harvesting together with limited energy storage may have certain limitations. For example, the power or energy provided to the wireless communication module may have a much larger variation in time and/or may otherwise be limited (i.e., may not be able to provide hundreds of mW for wireless communication).

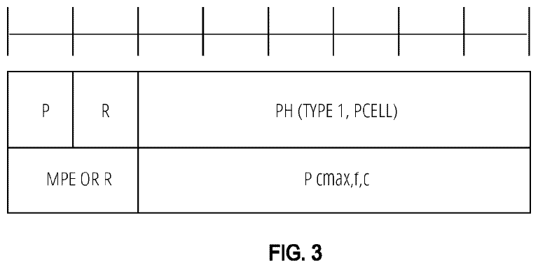

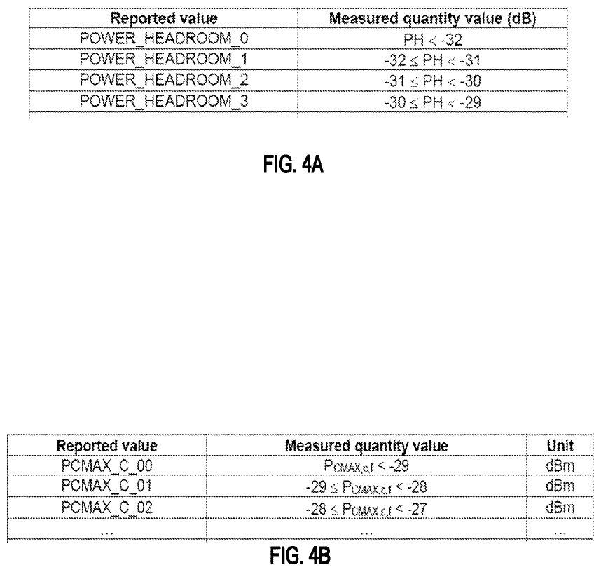

Thus, in certain embodiments, for wireless communication with energy harvesting, in terms of the PHR, the allowed report range for both power headroom (PH) and the nominal UE transmit power level (i.e., P_(CMAX,f,c)), may be extended, such as by allowing a smaller value. By way of example, FIG. 3 illustrates a single entry PHR media access control (MAC) control element (CE) according to certain embodiments. See, e.g., 3GPP Technical Specification (TS) 38.321. As further examples, FIG. 4A is a table illustrating power headroom report mapping and FIG. 4B is a table illustrating mapping of P_(CMAX,f,c) according to certain embodiments. See, e.g., 3GPP TS 38.133 Table 10.1.17.1-1 and Table 10.1.18.1-1.

In certain embodiments, for wireless communication with energy harvesting, in terms of the PHR, the condition that the UE can report the PHR may be relaxed. For example, the UE may be allowed to report a new PHR if the nominal UE transmit power level has changed more than a configurable threshold. In certain existing systems, for example, a UE is only allowed to report PHR when the path loss has changed more than a configurable threshold. See., e.g., 3GPP TS 38.321 (stating that a PHR is triggered if phr-ProhibitTimer expires or has expired and the path loss has changed more than phr-Tx-PowerFactorChange dB for at least one reference signal (RS) used as pathloss reference for one activated serving cell).

In certain embodiments, for wireless communication with energy harvesting, in terms of the PHR, the UE may report PHR in uplink control information (UCI) in Layer 1 (L1). The NW may configure the PHR report as one of the report quantities in the CSI report. Consequently, the NW may configure three different time domain behaviors of the PHR report in L1 including: periodic PHR report; semi-persistent PHR report; and/or aperiodic PHR report.

In certain embodiments, for wireless communication with energy harvesting, in terms of the PHR, if the PHR can be reported as channel state information (CSI) in UCI, in terms of the CSI priority, the PHR report may have a different priority than L1 reference signal received power (RSRP) and/or signal-to-noise and interference ratio (SINR), and other CSI report. For example, the PHR may have a higher priority than L1-RSRP/SINR. In another embodiment, the PHR report has the same priority as either L1-RSRP/SINR or other CSI Report.

By way of example, as stated in 3GPP TS 38.214, CSI reports are associated with a priority value Pri_{iCST}(y, k, c, s)=2·N_{cells}·Mₛ·y+N_{cells}·Mₛ·k+Mₛ·c+s, where y=0 for aperiodic CSI reports to be carried on PUSCH, where y=1 for semi-persistent CSI reports to be carried on PUSCH, where y=2 for semi-persistent CSI reports to be carried on PUCCH, where y=3 for periodic CSI reports to be carried on PUCCH, where k=0 for CSI reports carrying L1-RSRP or L1-SINR, where k=1 for CSI reports not carrying L1-RSRP or L1-SINR.

In certain embodiments, for wireless communication with energy harvesting, in terms of the PHR, if the PHR is reported in a MAC-CE (as in certain current systems), under certain conditions (e.g., when the PHR or normal UE transmit power change exceeds a threshold and the UE has no available UL grant for UL transmission), then the UE may use a scheduling request (SR) to request UL grant to update the PHR.

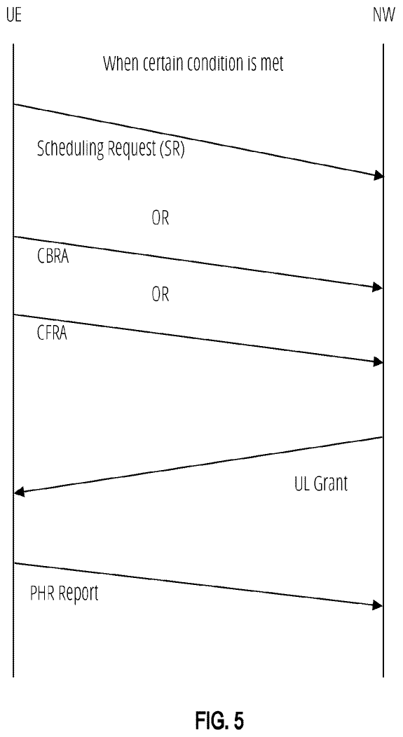

For example, FIG. 5 is a signal diagram illustrating between a UE and a network (NW) for UE PHR report enhancement according to one embodiment. When the certain conditions are met, as discussed above, the UE sends an SR to the NW. The SR may be specifically configured by the NW and assigned with higher priority compared to the other SR. In response, the NW sends a UL grant to the UE so that the UE can use the UL grant to transmit the PHR. According to the update, the UE sends the PHR report to the NW. In other embodiments, rather than using an SR, as shown in FIG. 5, the UE may use contention based random access (CBRA) or contention free random access (CFRA) to request an UL resource for the PHR report.

### UE Energy Status Report (ESR)

In certain embodiments, for wireless communication with energy harvesting, a new report may be introduced from the UE to the NW. The new report informs the NW about the UE energy status. The ESR from the UE may inform the NW about one or multiple of the following: the energy level of the energy storage unit; the desired energy harvest frequency; the desired energy harvest RF signal strength; and/or the desired energy harvest duration. The ESR may be reported from the UE via MAC-CE/UCI (or RRC).

In certain embodiments, for wireless communication with energy harvesting, when a new report (i.e., the ESR) is introduced, one or multiple of the following may be considered: the ESR is configured as a periodic report by the NW; the ESR is triggered as an aperiodic report by the NW; and/or the ESR is triggered and reported aperiodically by the UE under certain conditions (e.g., when the energy storage or harvested energy is not enough to sustain wireless communication).

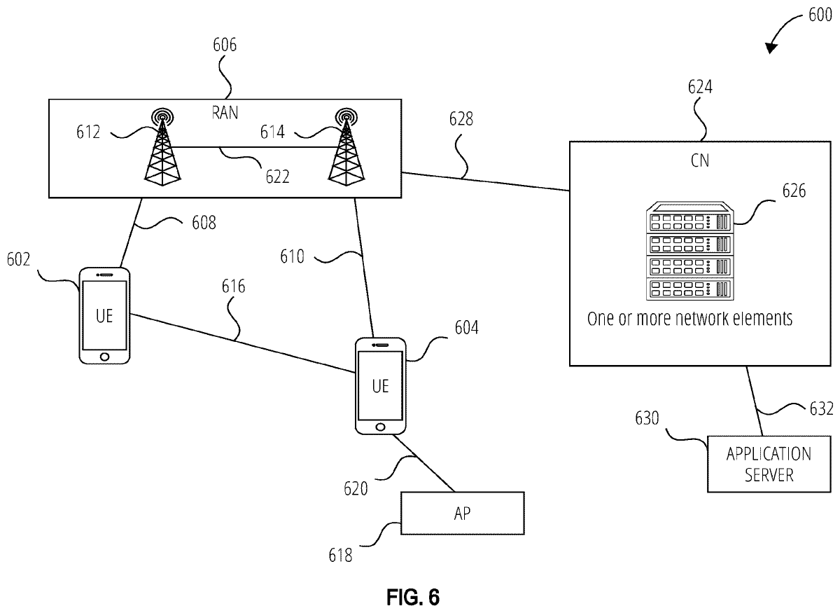

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations (such as base station 612 and base station 614) that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the SI interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

FIG. 7 illustrates a system 700 for performing signaling 734 between a wireless device 702 and a network device 718, according to embodiments disclosed herein. The system 700 may be a portion of a wireless communications system as herein described. The wireless device 702 may be, for example, a UE of a wireless communication system. The network device 718 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 734) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include an energy harvest module 716. The energy harvest module 716 may be implemented via hardware, software, or combinations thereof. For example, the energy harvest module 716 may be implemented as a processor, circuit, and/or instructions 708 stored in the memory 706 and executed by the processor(s) 704. In some examples, the energy harvest module 716 may be integrated within the processor(s) 704 and/or the transceiver(s) 710. For example, the energy harvest module 716 may be implemented by a combination of software components (e.g., executed by a DSP or a general processor) and hardware components (e.g., logic gates and circuitry) within the processor(s) 704 or the transceiver(s) 710.

The energy harvest module 716 may be used for various aspects of the present disclosure, for example, aspects of FIG. 1 to convert RF energy to electrical energy for storage or use in wireless communication.

The network device 718 may include one or more processor(s) 720. The processor(s) 720 may execute instructions such that various operations of the network device 718 are performed, as described herein. The processor(s) 720 may include one or more baseband processors implemented using, for example, a CPU, a DSP, an ASIC, a controller, an FPGA device, another hardware device, a firmware device, or any combination thereof configured to perform the operations described herein.

The network device 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The network device 718 may include one or more transceiver(s) 726 that may include RF transmitter and/or receiver circuitry that use the antenna(s) 728 of the network device 718 to facilitate signaling (e.g., the signaling 734) to and/or from the network device 718 with other devices (e.g., the wireless device 702) according to corresponding RATs.

The network device 718 may include one or more antenna(s) 728 (e.g., one, two, four, or more). In embodiments having multiple antenna(s) 728, the network device 718 may perform MIMO, digital beamforming, analog beamforming, beam steering, etc., as has been described.

The network device 718 may include one or more interface(s) 730. The interface(s) 730 may be used to provide input to or output from the network device 718. For example, a network device 718 that is a base station may include interface(s) 730 made up of transmitters, receivers, and other circuitry (e.g., other than the transceiver(s) 726/antenna(s) 728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 718 may include an energy module 732. The energy module 732 may be implemented via hardware, software, or combinations thereof. For example, the energy module 732 may be implemented as a processor, circuit, and/or instructions 724 stored in the memory 722 and executed by the processor(s) 720. In some examples, the energy module 732 may be integrated within the processor(s) 720 and/or the transceiver(s) 726. For example, the energy module 732 may be implemented by a combination of software components (e.g., executed by a DSP or a general processor) and hardware components (e.g., logic gates and circuitry) within the processor(s) 720 or the transceiver(s) 726.

The energy module 732 may be used for various aspects of the present disclosure, for example, for the network to configure wireless communication with energy harvesting.

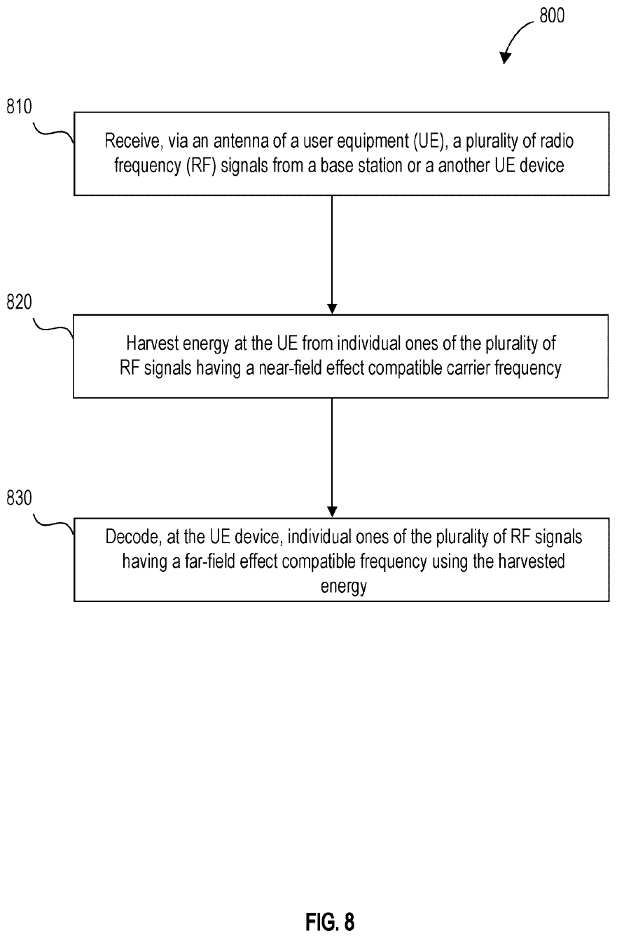

FIG. 8 illustrates a flowchart for a method 800 to harvest RF energy for wireless communications, according to embodiments disclosed herein. The method 800 may be performed by the wireless communications device 100 of FIG. 1, any of the UEs 602 of FIG. 6, and/or the wireless device 702 of FIG. 7.

The method 800 includes receiving, via an antenna of a UE, a plurality of RF signals from a base station or another UE device, at 810. The antenna may include one or more of the antenna(s) 712 of FIG. 7. The base station may include any of the base stations 612 or 164 of FIG. 6 and/or the network device 718 of FIG. 7. The another user equipment may include the wireless communications device 100 of FIG. 1, any of the UEs 602 of FIG. 6, and/or the wireless device 702 of FIG. 7.

The method 800 further includes harvesting energy at the UE from individual ones of the plurality of RF signals having a near-field effect compatible carrier frequency, at 820. The energy may be harvested via an energy harvest module, such as the energy harvest module 102 of FIG. 1 and/or the energy harvest module 716 of FIG. 7. In some examples, the method 800 may further include storing, at an energy storage module of the UE, some of the harvested energy. The energy storage module may include the energy storage module 104 of FIG. 1. In some examples, the method 800 may further include providing at least some of the stored energy to power the UE.

The method 800 further includes decoding, at the UE device, individual ones of the plurality of RF signals having a far-field effect compatible frequency using the harvested energy, at 830. The signals may be decoded via a wireless communications module, such as the wireless communication module 106 of FIG. 1 and/or the transceivers 710 of FIG. 7. In some examples, the method 800 includes transmitting, from the UE, a second plurality of RF signals using the near-field effect compatible carrier frequency using the harvested energy. In some examples, the far-field effect compatible carrier frequency is at least 400 MHz and the near-field effect compatible carrier frequency is at most 100 MHz. In some examples, the method 800 may further include, while using the harvested energy, limiting receipt and transmission of RF signals to single component carrier operation.

In some examples, the method 800 may further include, while using the harvested energy, indicating a low power class or UE category via transmission of a UE device identifier or transmission of a UE capability report.

In some examples, the method 800 may further include, while using the harvested energy, transmitting power headroom, nominal power, or a combination thereof in a power headroom report when transmit power of the UE has changed by more than a predetermined amount. In some examples, the method 800 may further include including the power headroom report in uplink control information. In some examples, the method 800 may further include including the power headroom report as channel state information in the uplink control information. In some examples, the method 800 may further include including the power headroom report in a medium access control (MAC) control element (CE).

In some examples, the method 800 may further include, while using the harvested energy, transmitting a UE energy status report (ESR) as configured by a base station. In some examples, the method 800 may further include including an energy level of an energy storage unit, a desired frequency for the near-field effect compatible carrier frequency, a desired energy harvest RF signal strength, a desired energy harvest duration, or any combination thereof in the UE ESR. In some examples, the method 800 may further include receiving, at the UE, an instruction to transmit the UE ESR periodically or aperiodically.

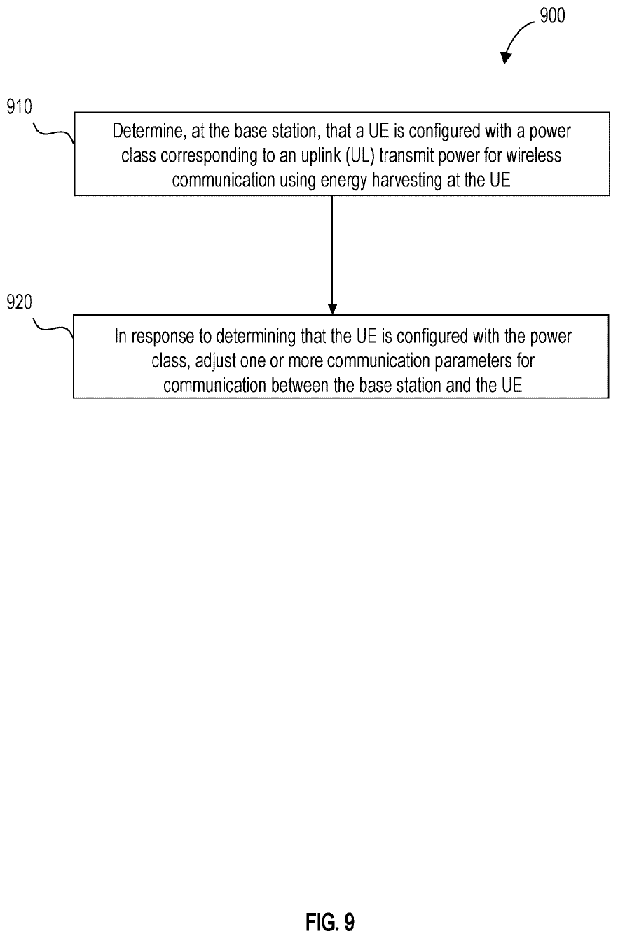

FIG. 9 illustrates a flowchart for a method 900 to operate a base station to communicate with a UE that harvests RF energy for wireless communications, according to embodiments disclosed herein. The method 900 may be performed by any of the base stations 612 or 164 of FIG. 6 and/or the network device 718 of FIG. 7.

The method 900 includes determining, at the base station, that a user equipment (UE) is configured with a power class corresponding to an uplink (UL) transmit power for wireless communication using energy harvesting at the UE, at 910. The UE may include the wireless communications device 100 of FIG. 1, any of the UEs 602 of FIG. 6, and/or the wireless device 702 of FIG. 7. The power class may be associated with a predetermined UE category.

In some examples, determining that the UE is configured with the power class includes receiving, at the base station from the UE, a UE capability report indicating the power class. In some examples, determining that the UE is configured with the power class includes receiving, at the base station from the UE, a UE device identifier (ID), and associating the UE device ID with the power class.

The method 900 further includes in response to determining that the UE is configured with the power class, adjusting one or more communication parameters for communication between the base station and the UE, at 920. In some examples, the one or more communication parameters are selected from a group comprising a maximum number of downlink (DL) multiple input multiple output (MIMO) layers, a maximum number of UL MIMO layers, a number of hybrid automatic repeat request (HARQ) processes, a maximum bandwidth, a modulation and coding scheme (MCS), a maximum UL duty cycle, a maximum DL duty cycle, a maximum UL peak data rate, a maximum DL peak data rate, and a limit to single component carrier (CC) operation.

In some examples, the method 900 may further include configuring a power headroom report (PHR) for the UE based on the power class associated with energy harvesting at the UE. In some examples, the method 900 may include configuring the PHR to be received from the UE when UL transmit power changes more than a configured threshold value. In some examples, the method 900 may include configuring the PHR to be received from the UE in uplink control information (UCI) in layer 1 (L1). In some examples, the PHR includes a report quantity in a channel state information (CSI) report.

In some examples, the method 900 may include configuring, by the base station, the PHR for one of periodic, semi-persistent, or aperiodic reporting. In some examples, the PHR may have a different priority than at least one of an L1 reference signal received power (RSRP), a signal-to-noise and interference ratio (SINR), and another CSI report. Additionally or alternatively, the PHR may have a same priority as at least one of an L1 reference signal received power (RSRP), a signal-to-noise and interference ratio (SINR), and another CSI report.

In examples where the PHR is configured to be received from the UE in a media access control (MAC) control element (CE), when the PHR or the UL transmit power exceeds a predetermined threshold, the method 900 may further include receiving, at the base station from the UE, a request for a UL grant in a scheduling request (SR), a contention based random access (CBRA) procedure, or a contention free random access (CFRA) procedure; in response to the request, configuring an UL resource for the PHR; and receiving, at the base station from the UE, the PHR in the UL resource.

In some examples, the method 900 may further include receiving, at the base station from the UE, an energy status report (ESR) indicating one or more of an energy level of an energy storage unit of the UE, an energy harvest frequency requested by the UE, an energy harvest radio frequency (RF) signal strength requested by the UE, and an energy harvest duration requested by the UE. In some examples, the method 900 may further include receiving the ESR in a media access control (MAC) control element (CE) or a radio resource control (RRC) message. In some examples, the ESR may be configured as periodic by the base station, triggered as aperiodic by the base station, or configured by the base station to be triggered and aperiodically reported by the UE when a condition is satisfied.

Embodiments contemplated herein include an apparatus comprising means to perform one or more elements of the UE-based methods disclosed herein. This apparatus may be, for example, an apparatus of a UE (such as a wireless device 702 that is a UE, as described herein).

Embodiments contemplated herein include one or more non-transitory computer-readable media comprising instructions to cause an electronic device, upon execution of the instructions by one or more processors of the electronic device, to perform one or more elements of the UE-based methods disclosed herein. This non-transitory computer-readable media may be, for example, a memory of a UE (such as a memory 706 of a wireless device 702 that is a UE, as described herein).

Embodiments contemplated herein include an apparatus comprising logic, modules, or circuitry to perform one or more elements of the UE-based methods disclosed herein. This apparatus may be, for example, an apparatus of a UE (such as a wireless device 702 that is a UE, as described herein).

Embodiments contemplated herein include an apparatus comprising: one or more processors and one or more computer-readable media comprising instructions that, when executed by the one or more processors, cause the one or more processors to perform one or more elements of the UE-based methods disclosed herein. This apparatus may be, for example, an apparatus of a UE (such as a wireless device 702 that is a UE, as described herein).

Embodiments contemplated herein include a signal as described in or related to one or more elements of the UE-based methods disclosed herein.

Embodiments contemplated herein include a computer program or computer program product comprising instructions, wherein execution of the program by a processor is to cause the processor to carry out one or more elements of the UE-based methods disclosed herein. The processor may be a processor of a UE (such as a processor(s) 704 of a wireless device 702 that is a UE, as described herein). These instructions may be, for example, located in the processor and/or on a memory of the UE (such as a memory 706 of a wireless device 702 that is a UE, as described herein).

Embodiments contemplated herein include an apparatus comprising means to perform one or more elements of the network-based methods disclosed herein. This apparatus may be, for example, an apparatus of a base station (such as a network device 718 that is a base station, as described herein).

Embodiments contemplated herein include one or more non-transitory computer-readable media comprising instructions to cause an electronic device, upon execution of the instructions by one or more processors of the electronic device, to perform one or more elements of the network-based methods disclosed herein. This non-transitory computer-readable media may be, for example, a memory of a base station (such as a memory 722 of a network device 718 that is a base station, as described herein).

Embodiments contemplated herein include an apparatus comprising logic, modules, or circuitry to perform one or more elements of the network-based methods disclosed herein. This apparatus may be, for example, an apparatus of a base station (such as a network device 718 that is a base station, as described herein).

Embodiments contemplated herein include an apparatus comprising: one or more processors and one or more computer-readable media comprising instructions that, when executed by the one or more processors, cause the one or more processors to perform one or more elements of the network-based methods disclosed herein. This apparatus may be, for example, an apparatus of a base station (such as a network device 718 that is a base station, as described herein).

Embodiments contemplated herein include a signal as described in or related to one or more elements of the network-based methods disclosed herein.

Embodiments contemplated herein include a computer program or computer program product comprising instructions, wherein execution of the program by a processing element is to cause the processing element to carry out one or more elements of the network-based methods disclosed herein. The processor may be a processor of a base station (such as a processor(s) 720 of a network device 718 that is a base station, as described herein). These instructions may be, for example, located in the processor and/or on a memory of the base station (such as a memory 722 of a network device 718 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a base station, the method comprising:
determining, at the base station, that a user equipment (UE) is configured with a power class corresponding to an uplink (UL) transmit power for wireless communication using energy harvesting at the UE;
determining the power class based on at least one of a predetermined UE category associated with the power class, a UE capability report indicating the power class, and a UE device identifier (ID) associated with the power class; and
in response to determining that the UE is configured with the power class, adjusting one or more communication parameters for communication between the base station and the UE.

2. The method of claim 1, wherein the one or more communication parameters are selected from a group comprising a maximum number of downlink (DL) multiple input multiple output (MIMO) layers, a maximum number of UL MIMO layers, a number of hybrid automatic repeat request (HARQ) processes, a maximum bandwidth, a modulation and coding scheme (MCS), a maximum UL duty cycle, a maximum DL duty cycle, a maximum UL peak data rate, a maximum DL peak data rate, and a limit to single component carrier (CC) operation.

3. The method of claim 1, further comprising configuring a power headroom report (PHR) for the UE based on the power class associated with energy harvesting at the UE.

4. The method of claim 3, further comprising configuring the PHR to be received from the UE when UL transmit power changes more than a configured threshold value.

5. The method of claim 3, further comprising configuring the PHR to be received from the UE in uplink control information (UCI) in layer 1 (L1).

6. The method of claim 5, wherein the PHR comprises a report quantity in a channel state information (CSI) report.

7. The method of claim 6, further comprising configuring, by the base station, the PHR for one of periodic, semi-persistent, or aperiodic reporting.

8. The method of claim 6, wherein the PHR has a different priority than at least one of an L1 reference signal received power (RSRP), a signal-to-noise and interference ratio (SINR), and another CSI report.

9. The method of claim 6, wherein the PHR has a same priority as at least one of an L1 reference signal received power (RSRP), a signal-to-noise and interference ratio (SINR), and another CSI report.

10. The method of claim 3, wherein the PHR is configured to be received from the UE in a media access control (MAC) control element (CE), and wherein when the PHR or the UL transmit power exceeds a predetermined threshold, the method further comprises:
receiving, at the base station from the UE, a request for a UL grant in a scheduling request (SR), a contention based random access (CBRA) procedure, or a contention free random access (CFRA) procedure;
in response to the request, configuring an UL resource for the PHR; and
receiving, at the base station from the UE, the PHR in the UL resource.

11. The method of claim 1, further comprising receiving, at the base station from the UE, an energy status report (ESR) indicating one or more of an energy level of an energy storage unit of the UE, an energy harvest frequency requested by the UE, an energy harvest radio frequency (RF) signal strength requested by the UE, and an energy harvest duration requested by the UE.

12. The method of claim 11, further comprising receiving the ESR in a media access control (MAC) control element (CE) or a radio resource control (RRC) message.

13. The method of claim 11, wherein the ESR is configured as periodic by the base station, triggered as aperiodic by the base station, or configured by the base station to be triggered and aperiodically reported by the UE when a condition is satisfied.

14. A user equipment (UE), comprising:
an antenna configured to receive a plurality of radio frequency (RF) signals from a base station or another UE device;
an energy harvest module coupled to the antenna and configured to receive the plurality of RF signals and to harvest energy from individual ones of the plurality of RF signals having a near-field effect compatible carrier frequency; and
a wireless communications module coupled to the antenna and configured to receive the plurality of RF signals and to decode individual ones of the plurality of RF signals having a far-field effect compatible frequency using the energy harvested by the energy harvest module, wherein, while using the energy harvested by the energy harvest module, the wireless communications module is configured to indicate a low power class or UE category via transmission of a UE device identifier or transmission of a UE capability report.

15. The UE of claim 14, wherein the wireless communications module is further configured to transmit a second plurality of RF signals using the near-field effect compatible carrier frequency using the energy harvested by the energy harvest module.

16. The UE of claim 15, wherein a total transmit power of the wireless communications module is less than 100 micro-watts.

17. The UE of claim 14, wherein the far-field effect compatible carrier frequency is at least 400 MHz and the near-field effect compatible carrier frequency is at most 100 MHz.

18. The UE of claim 14, wherein, while using the energy harvested by the energy harvest module, the wireless communications module is limited to single component carrier operation.

19. The UE of claim 14, further comprising an energy storage module configured to store some of the energy harvested by the energy harvest module as stored energy.

20. The UE of claim 19, wherein the energy storage module is configured to provide at least some of the stored energy to the wireless communications module to power the wireless communications module.

21-40. (canceled)
